(19) United States
(12) Patent Application Publication
(10) Pub. No.: US 2005/0103233 A1
(43) Pub. Date: May 19, 2005

(54) Tint for drywall

(76) Inventor: Christopher T. Rood, Annandale, MN (US)

Correspondence Address: LITMAN LAW OFFICES, LTD., P.O. BOX 15035 CRYSTAL CITY STATION, ARLINGTON, VA, 22215, US

(21) Appl. No.: 10/706,969

(22) Filed: Nov. 14, 2003

(51) Int. Cl. C04B 12/04

(52) U.S. Cl. 106/611

(57) ABSTRACT

A tint containing plaster composition for filling in gaps between abutting drywall panels as well as screw holes, cracks, nail pops, and dings is supplied in capped tubes to indicate that the gaps and imperfections are visible on a white wall for drywall touch ups. A yellow tint is preferred.

### BACKGROUND OF THE INVENTION

1. Field of the Invention

The present invention relates generally to drywall plaster compounds. More specifically, the invention is a yellow drywall tint in a small capped tube for making visible the drywall mud between panels and for touching up screw holes, cracks, nail pops and dings in plasterboard panels.

2. Description of the Related Art

The related art of interest describes various compositions and methods of adding plaster in the gaps between installed drywall or plasterboard panels, but none discloses the present invention. The relevant art will be distinguished and discussed in the order of relevance to the present invention.

U.S. Pat. No. 6,476,099 B1 issued on Nov. 5, 2002, to Scott D. Cimaglio et al. describes a joint compound additive for the reduction of cracking, cratering and shrinkage upon application to a drywall comprising a filler, a binder and a hydrocarbon substituted sulfate, sulfonate, sulfuric acid or sulfonic acid. Although there is incidental disclosure of yellow iron oxide in the comparative example 1 of a generic joint compound, there is also a negative teaching of using soap additives including colored soaps. The joint compound additive is distinguishable for teaching against the addition of a colored additive to joint paste compositions.

U.S. Pat. No. 4,780,161 issued on Oct. 25, 1988, to Howard Mizuhara describes an alumina tube made by joining tubes having tapered ends coated with a composition containing alumina and firing at a high temperature. A few drops of red dye were added to the coating mixture to aid in applying a uniform coating. The composition is distinguishable in being utilized for a sintering operation.

U.S. Pat. No. 5,746,822 issued on May 5, 1998, to Therese A. Espinoza et al. describes a ready-mixed setting type joint compound comprising the addition of red iron oxide as a visual indicator of the blending uniformity. The composition is distinguishable for the required addition of iron oxide for a ceramic blending mixture operation.

U.S. Pat. No. 6,531,528 B1 issued on Mar. 11, 2003, to Ronald D. Kurp describes a ready to use spackle product containing a color change indicator to signal the product has dried. A color change indicator such as phenolphthalein et al. is added to the spackle composition to reveal a color, but losing color upon drying of the applied product. The additives are distinguishable for being limited to having a property of losing color upon drying of the spackle.

U.S. Pat. No. 4,883,538 issued on Nov. 28, 1989, to Raymond Marlow et al. describes a colored thermal joint compound comprising the addition to either a zinc oxide in silicone oil or a mineral oil base composition a colloidal sized and colored calcium carbonate powder. The addition of a colored calcium carbonate powder to a thermal joint compound is distinguishable for being an incidental disclosure.

U.S. Pat. No. 5,853,473 issued on Dec. 29, 1998, to Harold Donaldson describes a patching composition for concrete surfaces comprising Portland cement, silica sand and calcium oxide. Red iron oxide pigment was added to match a concrete surface. The composition is distinguishable for requiring the pigment to match a colored concrete surface.

Japan Patent Publication No. 2003-2076 published on Jan. 24, 2003, for Masaaki Takahashi et al. describes a joint sealing compound among other improvements to effect waterproofing efficiency of a building wall. The joint sealing compound is distinguishable for being limited to a building wall and requiring repeated additions.

None of the above inventions and patents, taken either singly or in combination, is seen to describe the instant invention as claimed. Thus, a tint for drywall gaps solving the aforementioned problems is desired.

### SUMMARY OF THE INVENTION

The tint paste for drywall panel gaps or seams o the handyman that the touch up has been made. Other useful applications include filling in of screw holes, cracks, nail pops, and dings present in a drywall panel. A yellow tint is preferred.

Accordingly, it is a principal object of the invention to provide an indicator in the plastering of drywall panel seams, screw holes, cracks, nail pops, and dings.

It is another object of the invention to provide an indicator to the handyman that the touch up has been made.

It is a further object of the invention to provide an indicator paste having a distinct yellow color in a tube.

Still another object of the invention is to provide a tubed indicator paste having a yellow ocher color.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a handyman applying tint paste to a drywall seam according to the present invention.

FIG. 2 is a side elevational view of a drywall tint containing capped tube according to the present invention.

Similar reference characters denote corresponding features consistently throughout the attached drawings.

### DETAILED DESCRIPTION OF THE PREFERRED EMBODIMENT

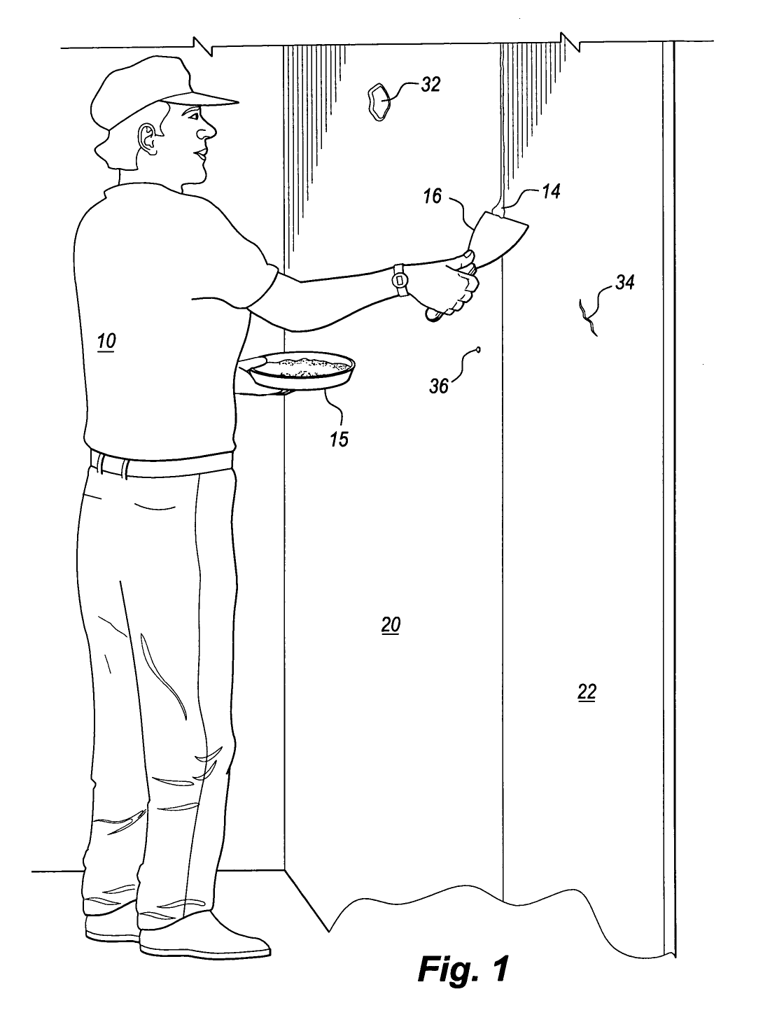

The present invention illustrated in FIGS. 1 and/or 2 is directed to a plasterer workman 10 using a tube 12 of a yellow tinted plaster composition 14 to apply from the tube nozzle 16 a tinted plaster deposit 18 to a plastered gap between the left drywall panel 20 and the right drywall panel 22 for identifying recently added drywall paste to the workmen.

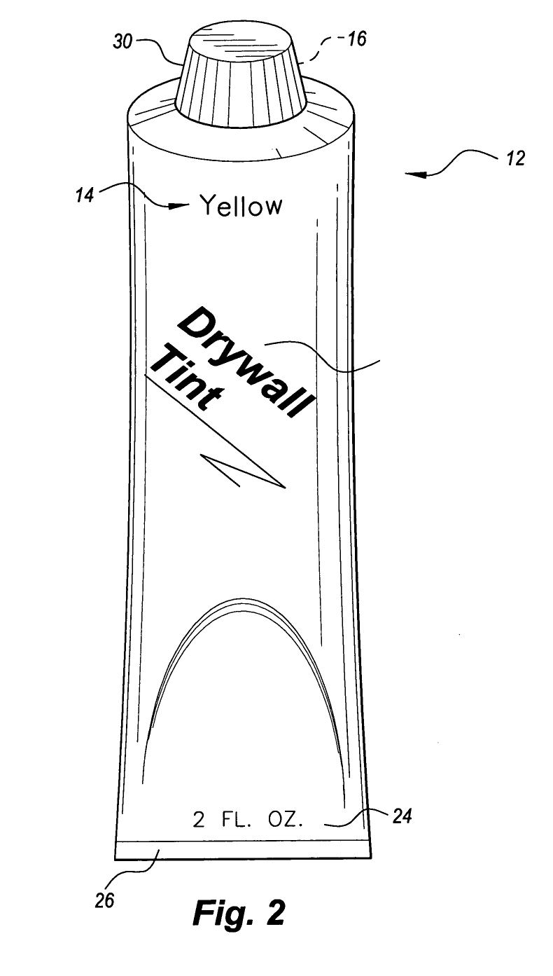

In FIG. 2, the squeezable plastic or metal tube 12 is shown marked with a “Yellow” indicia 14. The tube 12 is identified as having a volume 24 of 2 fluid ounces as an illustrative example at the crimped, end 26. The tube 12 is further identified as being a “Drywall Tint” 28. The hidden threaded nozzle 16 has a screw off threaded cap 30. The invention is not to be limited to the container tube, but can also be contained in a bottle with a dipstick.

A preferred yellow tint is yellow ocher added to a conventional plaster composition contained in a squeezable and capped tube.

Thus, a means for identifying filled plaster gaps between drywall panels has been shown which would eliminate any confusion as to whether the gaps have been adequately filled. Other applications include touch-ups for filling in screw holes, cracks, nail pops, and dings in installed drywall panels.

It is to be understood that the present invention is not limited to the embodiment described above, but encompasses any and all embodiments within the scope of the following claims.

1. A tint composition for filling in drywall panel gaps, screw holes, cracks, nail pops, and dings comprising:
a binder;
a filler;
a surfactant; and
a light color tint.

2. The tint composition for filling in drywall panel imperfections according to claim 1, wherein the light color tint is yellow.

3. The tint for drywall panel imperfections according to claim 2, wherein the yellow tint is yellow ocher.

4. A method of identifying the touching up adequacy of applied drywall paste between drywall panels and in screw holes, cracks, nail pops, and dings comprising:
applying drywall paste to fill in the gaps between installed drywall panels and in screw holes, cracks, nail pops, and dings;
drying the applied drywall paste; and
applying a tinted drywall paste to touch up the applied drywall paste;
whereby identification of the touch up paste notifies the plasterer that a touch up has been made.

5. The method according to claim 4, wherein the tint is yellow.

6. The method according to claim 5, wherein the yellow tint is yellow ocher.
